(19) United States
(12) Patent Application Publication
(10) Pub. No.: US 2002/0016817 A1
(43) Pub. Date: Feb. 7, 2002

(54) Telecommunication network, method of operating same, and terminal apparatus therein

(76) Inventor: Gero Offer, Gilching (DE)

Correspondence Address: Bell, Boyd & Lloyd LLC, P.O. Box 1135, Chicago, IL, 60690, US

(21) Appl. No.: 09/899,435

(22) Filed: Jul. 5, 2001

(30) Foreign Application Priority Data
Jul. 4, 2000 (EP) 00114333.8

(51) Int. Cl. G06F 15/16

(52) U.S. Cl. 709/203

(57) ABSTRACT

A telecommunication network with a number of terminal devices and a central server of an access or service provider, whereby the server includes an interrogation part for interrogating the hardware and software configurations of the terminal devices and a software transmitting part for loading software and/or data that are suited to the detected hardware and software configuration onto the terminal devices, and whereby the terminal devices include a response transmitting part for transmitting a configuration code to the server identifying the hardware and software configuration.

### BACKGROUND OF THE INVENTION

1. Field of the Invention

The present invention relates to a telecommunication network with a central server of an access or service provider, a method for operating such a telecommunication network, and terminal equipment that is used in same.

2. Description of the Prior Art

For years, telecommunication networks have been developing from initially pure telephone networks into multivalent communication and information networks. With the rapid spreading of mobile communications, which has already surpassed the limits of telephony despite the short time in which it has been available, and which is being developed into a high-grade information and service provision instrument by the recent connection with the Internet via the wireless application protocol (WAP), the competition among network and service providers is taking on new dimensions. New information resources and services are being made available to subscribers with great rapidity.

Whereas in the past the establishment of new services in a telecommunication network necessitated the updating of control programs in the exchanges and a correspondingly high cost outlay, as well as certain risks with respect to the operational reliability of the network, in the intelligent network (IN) concept, services beyond the pure switching and transmission functions are combined in separate network nodes. On this basis, new services can be provided centrally, instead of having to take effect via separate software in each exchange as in the past. This makes it possible to accelerate the introduction of new services into telecommunication networks and represents the technical basis for the abovementioned rapid expansion of the supply of new services both in the mobile radiotelephone networks and in stationary networks.

In practice, the hardware and software configuration of the terminal devices can no longer keep pace with these rapid developments of the performance spectrum of the networks while maintaining an economically reasonable use-life. Although terminal devices (mobile radiotelephones, stationary network telephones, fax machines) with new, more powerful hardware and software are continually entering the market, within a short time they are often outgrown by the developing supply services of the respective network. Therefore, it is usually necessary to forgo part of the services provided at the network side after a short time, occasionally even given newly designed equipment.

In an older German patent application (DE 19928778 A1), a method is laid out for operating a terminal device in an intelligent network, in which the data relating to the software configuration of the terminal equipment is autonomously updated by way of the intelligent periphery of the network subsequent to a comparison with the data stored in an application software database. This method is still limited in its range of application.

The international patent application WO 97/16938 teaches a telecommunication network which includes a database having programs for upgrading a mobile radiotelephone and a program transmission device for loading these programs onto the mobile radiotelephone. When the mobile radiotelephone logs onto the telecommunication network, the network inquires which software the mobile radiotelephone contains. If the data bank of the telecommunication network contains more suitable programs than those already stored on the mobile telephone, the program transmission device informs the mobile radiotelephone of the possibility of loading these programs onto the mobile radiotelephone. With the approval of a user of the telephone, the programs are loaded onto the mobile radiotelephone.

The international patent application WO 98/58506 teaches a system for configuring mobile radiotelephones with programs. The programs are filed in data memories which can be accessed from a communication network. Programs which are allocated to the mobile radiotelephones are transferred to the mobile radiotelephones by way of the communication network with the aid of location information of the telephones.

It is an object of the present invention to lay out an improved telecommunication network, a method for operating it, and a terminal apparatus, which collectively make possible a flexible updating of the software configuration of the terminal equipment operating at the network in accordance with specific offers and the specific wishes of the respective user.

### SUMMARY OF THE INVENTION

The present invention, accordingly, involves the basic idea of executing a download of software and/or data from a central server of an access or service provider in the network onto the terminal devices in an interactive control process with the aid of a distributed control including the functional components of the server and components of the terminal devices. The present invention further is directed to the idea that in the logon of a terminal device onto the network, or periodically (i.e., at predetermined times or at predetermined intervals), an interrogation of the current hardware and software configuration automatically occurs and, in response, a code which identifies the current configuration is automatically transmitted. This guarantees that regular downloads can be provided to the users which are specifically tuned to their terminal equipment, thus allowing better usage of the network resources or the realization of additional functions of their terminal devices. In the context of the proposed solution, various usage conditions (time-limited use, use with superimposed advertisements, single payment, use-based payment, etc.) are offered to the users. In the corresponding network and method embodiments, distributed control is designed for the interactive determination of a charging mode for the downloads.

The distributed control part advantageously includes: an offer memory which is addressable by way of the aforementioned configuration code, in whose memory areas lists are kept of software or data offers (offer information) which are tuned to a specific hardware and software configuration of the terminal devices; an offer transmitting device for transmitting the offer information to the terminal devices; and a transmission initiation unit for triggering the downloading of desired software and/or data onto the respective terminal device at the server side; as well as an offer display for displaying the offer information and requesting a way to select or reject offered software and/or data on the terminal device side. With this overall configuration, an active marketing of software and data downloads is realized, in the scope of which the respective terminal device is checked for its capabilities, and the respectively possible downloads are specifically offered in dependence upon the user profile; i.e., the terminal device profile.

In an embodiment, the proposed idea includes the storing of user rejections of download offers in the server in order to prevent the repetition of unwanted offers. The repeated offering of downloads which are desired by the user (and have meanwhile been realized) is prevented by a natural change of the software configuration of the terminal device, and with it the configuration code identifying it, with each downloading of additional software and/or additional data.

To accomplish this, the server is provided with a charging mode memory for storing the possible charging modalities in association with the offered software components and records and a charging mode transmitting device for transmitting identifiers of the possible charging modes to the user terminal devices; as well as a charging mode display therein for displaying the offered charging modes and a charging mode confirmation device for specifying the charging mode to be used at the user side.

Specifically for use-based charging, appropriate software with encrypted application counters is offered, which makes it possible to obtain the periodic usage level. In this embodiment, the server can accommodate an arithmetic evaluation unit for evaluating the counter status of the application counter and a usage information transmission unit, as well for transmitting messages relating to the status of the application counter to the respective terminal device user. This makes possible a use-based charging which is reproducible to the user at any time and which therefore enjoys a high degree of user acceptance.

In another embodiment, which offers subscribers a useful auxiliary function of the network, there are distributed devices provided in the server and the terminal devices for realizing backup and restore functions for records (telephone books, settings, etc.) or software components (individual auxiliary software) which are filed on the terminal device. This way, the inexpensive securing of data in case of a defect or loss of his/her terminal device are made available to the user.

To this end, the server includes a terminal equipment operating data memory and an operating data reception and transmitting part connected thereto for transmitting software and/or data which are implemented in the terminal devices to the server and, if necessary, back to the terminal devices; and on their part the terminal devices also include a corresponding operating data transmission and receiving part. These are connected to the abovementioned control part for realizing an interactive control, the connection being such that a backup or security data storage in the server only occurs upon the selection by the user of the terminal device of a corresponding offer of the access or service provider.

With the abovementioned way of storing and transmitting operating data (and operating software), the server in the network also can function as an intermediate station in the loading of software and/or data onto one terminal device by another terminal device in the network or by a data terminal device in a data network which is linked to the telecommunication network.

In another advantageous embodiment of the present invention, the server includes a storage unit for storing validity and/or authorization data in association with predetermined possible configuration codes, and a comparison unit which is connected to this storage unit and which compares the configuration codes that are transmitted by the terminal devices periodically or in the logon process to the stored codes. Given a suitable selection of the coding, it is thus possible to determine the validity of software and/or data stocks that are stored in the terminal devices; i.e., the usage authorization of the respective user for this software or data. On the basis of the check result, warnings or offers to update or legalize software or data stocks can be outputted to the user by suitable transmitting and display devices. Furthermore, specific follow-up actions can be initiated by the server, for instance in the event of the discovery of unlicensed software.

The abovementioned control part can be formed in various ways in practice, in particular by network-specific signaling based on a SIM card or firmware and/or applets or scripts.

The software offered for downloading can be a matter of software components or data for implementing non-network-bound auxiliary functions of the terminal device (such as calendar functions, games, etc.) or for implementing auxiliary services (WAP-browsers, software for service administration and instant messaging, etc.) which are available in the network or in a data network that is connected to it, or can be a matter of update software or data for updating software or data stocks which are already stored in the terminal equipment.

Additional features and advantages of the present invention are described in, and will be apparent from, the Detailed Description of the Preferred Embodiments and the Drawings.

### DESCRIPTION OF THE DRAWINGS

FIG. 1 shows a block circuit diagram of the components of a mobile telephone as an example of a telecommunication terminal device and a service server as an example of a central server in a mobile telecommunication network in association with the teachings of the present invention.

### DETAILED DESCRIPTION OF THE PREFERRED EMBODIMENTS

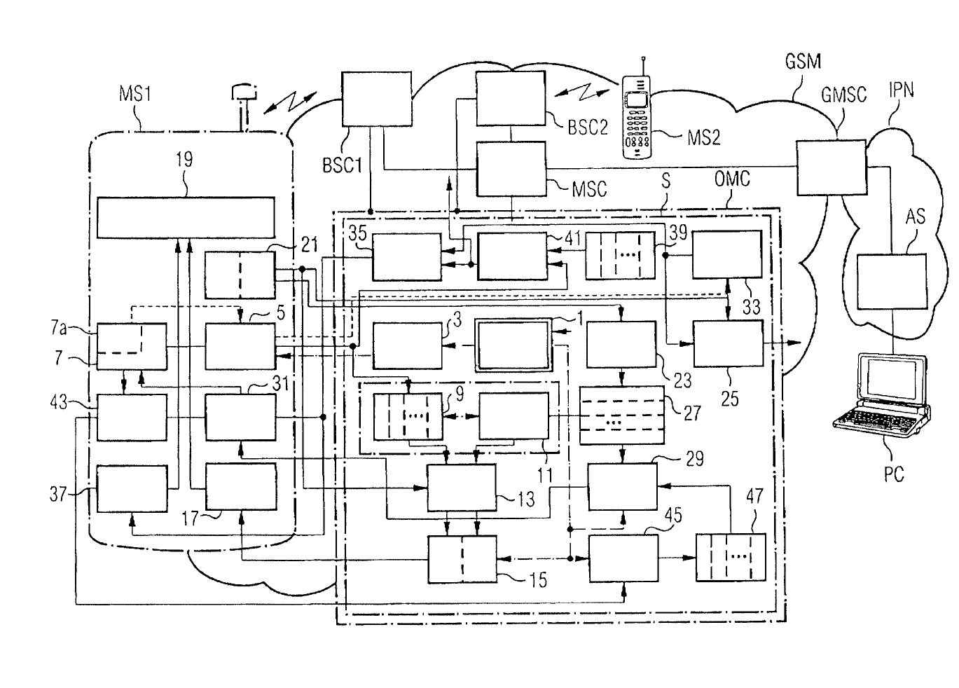

The general structure of the mobile radiotelephone network GSM is presumed to be known and, consequently, besides the mobile radiotelephone MS1 and a second MS2 as an additional telecommunication terminal device, FIG. 1 only includes the two allocated base stations BSC1 and BSC2 and a mobile exchange MSC. Furthermore, the position of the service server S in the block OMC in FIG. 1 makes clear that the service server is allocated to an operating and maintenance center OMC of the mobile radiotelephone network. Lastly, FIG. 1 illustrates that a connection of the mobile radiotelephone network to an IP network IPN, to which a data terminal device PC is connected by way of an access server AD, is produced by a gateway mobile exchange GMSC.

The service server S has a controller 1 for sequencing all functions, which receives a control signal (indicated by an in-arrow) by way of the base station BSC1 and the mobile exchange MSC when the mobile radiotelephone MS1 logs onto the network. At the output side, the controller 1 is first connected to an interrogation unit 3, which functions at this stage of the method as a configuration data interrogation unit and which is connected at the output side to a response transmission unit 5 of the mobile radiotelephone MS1, which it activates. On its part, the response transmission unit 5 is connected at the input side to a program storage unit 7 of the mobile radiotelephone and it receives configuration data therefrom which identify the current software configuration of the mobile radiotelephone and addresses an offer storage unit 9 of the service server S with the configuration record.

The offer storage unit 9 has a number of memory areas which are not individually referenced but which are each assigned a specific configuration record or code as an address and which each contain a current software update offer of the operator of the service server S, which offer is tailored to the terminal device configuration that is represented by the configuration code. A charging mode storage unit 11 in which charging modes that are available in connection with the software offer are listed is allocated directly to the offer storage unit 9. Subsequent to the addressing of one of the memory areas of the offer storage unit 9 with the aid of the transmitted configuration code, a list of the relevant charging modes is allocated to the offer list contained therein by an internal sequence control (not included in FIG. 1) and is outputted together with the offer list for transmission to the mobile radiotelephone MS1.

Connected to the outputs of the offer storage unit 9 and the charging mode storage unit 11, there is an offer filter unit 13, in which offers (downloads) that have already been rejected by the user once in an earlier offer are filtered out. The function of this filter unit will be described in greater detail below. Its outputs (for offer lists and charging mode lists) are connected to an offer transmission unit 15 of the service server S, which is controlled by the controller 1 and connected at the output side to an offer receiving unit 17 of the mobile radiotelephone.

The offer receiving unit 17 is connected to a display unit 19, on which the offer list and the available charging modes are displayed to the user. The user selects both the software he/she wishes to download and an appertaining charging mode in the context of a suitably designed menu control using a select key 21. The corresponding output signals go to a transmission initiation unit 23 and a charging unit 25 of the service server S, respectively.

The transmission initiation unit 23 is connected at the output side to a central software memory 27 and addresses this in response to the selection signal received by the mobile radiotelephone MS1. From the addressed memory areas for the individually available software components, the software desired by the subscriber is downloaded to the mobile radiotelephone MS1 by way of a server-side software transmission unit 29 and a terminal-device-side software receiving unit 31 and stored in the program storage unit 7 of the phone. The charging unit 25 stores the charging mode which is allocated to each desired software component at the user side internally for the running charging of the downloaded software.

In a particularly advantageous menu-driven control it is provided that the user can mark the components contained in the offer list with individual rejection markers. The signal processing unit which is connected to the select key 21 but which is not included in FIG. 1 then generates a reject signal for these software components which, just like a positive selection signal, is transmitted to the service server S; namely, to a separate control input of the offer filter unit 13 there. Here, a current user-specific “filter characteristic” is set on the basis of this input signal, with which the downloads that are expressly not wanted by the user can be filtered from the next offer list to be generated.

For a use-based charging mode, application counters are provided, which are known per se and are symbolized in FIG. 1 as area 7a of the program storage unit 7. A periodic readout of the counter statuses is initiated by the controller 1 and the interrogation unit 3, and the counter statuses are transmitted to an arithmetic evaluation unit 33 in the service server S by the application counters 7a via the response transmission unit 5. This computes the usage level accruing in the “read period” and outputs a corresponding signal to the charging unit 25, on the one hand, and to the mobile radiotelephone MS1 via an auxiliary information transmission unit 35 of the service server, on the other hand. There, this message is received by an auxiliary information receiving unit 37, edited for display on the display unit 19, and displayed there for the user.

Besides the aforementioned use-based charge determination, the present embodiment of the invention is also designed to check the currency, i.e. the validity, of software that is implemented in the mobile radiotelephone MS1 and the usage authorization of the user. To accomplish this, the service server includes a validation memory 39, in which validation and authorization records are stored in association with configuration records or codes, as well as a validation comparison unit, which is connected with a first input to the validation memory 39 and with a second input to the response transmission unit 5 of the mobile radiotelephone MS1 for receiving the current configuration records therefrom. The comparison result provides information about the currency status, i.e. the validity, of the software implemented in the mobile telephone and about the authorization of the user to use it. The corresponding output signal of the validation comparison unit 41 is outputted for additional evaluations and potentially the initiation of actions from the service server S side, on one hand, and displayed to the user via the auxiliary information transmission unit 35 of the server and the auxiliary information receiving unit 37 of the mobile radiotelephone and its display unit, on the other hand.

Another useful auxiliary function of the depicted embodiment consists in the possibility of providing a backup and restore storage of software and/or data from the mobile radiotelephone S in the server S. To this end, a backup transmission unit 43 is provided in the mobile radiotelephone, which is connected on the input side to the program storage unit 7 and on the output side to a backup receiving unit 45 of the service server S. The latter is connected, in turn, to a backup software memory 47, which includes a number of memory areas, each of which is allocated to a connected terminal device, for terminal-device-specific backup storage of the relevant terminal device software. A transmission of the software to be secured occurs during the logon of the mobile radiotelephone, and if necessary the software that is stored in the backup software memory 47 can be retransmitted back into the program storage unit 7 of the mobile radiotelephone by way of the software transmission unit 29 of the server and the software receiving unit 31 of the mobile radiotelephone, again under the control of the controller 1.

With the latter development of the arrangement, it is also possible to use the service server S as an intermediate storage area in the transmission of software components and/or records to the first mobile telephone MS1 from the second mobile radiotelephone MS2 or even from the data terminal device PC which is connected to the IP network IPN (3^{rd} party transmission).

The abovementioned services, particularly the latter service of backup and restore storage of software or records that are valuable to the user, are preferably offered as pay services and (analogously to the downloading of update software or additional data) are usually implemented as a result of the interactive negotiation of an offer with the prospective user.

Although the present invention has been described with reference to specific embodiments, those of skill in the art will recognize that changes may be made thereto without departing from the spirit and scope of the invention as set forth in the hereafter appended claims.

I claim as my invention:

1. A telecommunication network, comprising:
a central server of an access or service provider, the central server having an interrogation part for interrogating hardware and software configurations of a plurality of terminal devices and a software transmitting part for loading at least one of software and data that is customized to the respectively detected hardware and software configuration onto one of the plurality of terminal devices;
a plurality of terminal devices, each with a predetermined hardware and software configuration, each of the plurality of terminal devices including a response transmitting part for transmitting a configuration code identifying the respective hardware and software configuration to the central server in response to an inquiry by the interrogation part, each of the plurality of terminal devices also including a software receiving part for receiving and internally storing at least one of the transferred software and data, the interrogation part and the response transmitting part being designed to interrogate the respective hardware and software configuration and to transmit the respective configuration code when at least one of the terminal device logs onto the telecommunication network, predetermined times occur, and predetermined time intervals occur; and
distributed control parts, which are distributed in both the central server and the plurality of terminal devices, the distributed control parts implementing an interactive control over the software transmitting part, and being constructed for the interactive specifying of a charging mode for at least one of downloaded software and downloaded data.

2. A telecommunications network as claimed in claim 1, further comprising:
an offer memory in the central server to which the distributed control parts are connected, the offer memory being addressable via the configuration code and having a plurality of memory areas, in each of the memory areas at least one of a software and a data offer which is tuned to a separate hardware and software configuration is listed; and
wherein the distributed control parts include an offer transmitting part in the central server, the offer transmitting part for transferring contents of the respectively addressed offer memory area to the respective terminal device that has transmitted a configuration code, a transmission initiation unit in the central server, the transmission initiation unit for activating the transmitted part for loading at least one of software and data from at least one of the tuned software and the data offer, an offer display part in each of the plurality of terminal devices for displaying the memory contents of the respectively addressed offer memory area, and a requesting part in each of the plurality of terminal devices for selecting offered software and data for loading onto the terminal device, which send a request signal for at least one of desired software and data and a reject signal for unwanted software and data to the transmission initiation unit of the central server.

3. A telecommunication network as claimed in claim 2, wherein the central server further includes a reject signal storage area for terminal-device-specific storage of reject signals in association with the transmitted software and data offers, such that the reject signal storage area is allocated to the offer memory on an output side as filter so that software and data offers which are quit via a reject signal are not repeated to a same user.

4. A telecommunication network as claimed in claim 3, further comprising:
a charging mode memory in the central server to which the distributed control parts are connected, the charging mode memory being allocated to the offer memory and having at least one charging mode stored for at least one of each offered software item and each offered record; and
wherein the distributed control parts include a charging mode transmitting part in the central server connected to the charging mode memory for responding to the reception of one of a configuration code and a request signal, a charging mode display part in each of the plurality of terminal devices for displaying the at least one charging mode for at least one of the offered and the selected software and the offered and the selected data, and a charging mode confirmation part in each of the plurality of terminal devices for specifying the charging mode.

5. A telecommunication network as claimed in claim 1, wherein the central server further includes a terminal device operating data memory with a plurality of memory areas for the terminal-device-specific data storage of at least one of software and data that are implemented in the plurality of terminal devices, and operating data receiving and transmitting parts connected to the terminal device operating data memory for transferring the software and data from and to the plurality of terminal devices, and wherein each of the plurality of terminal devices further includes additional operating data transmitting and receiving parts for transferring the software and data to and from the central server.

6. A telecommunication network as claimed in claim 5, wherein the operating data receiving and transmitting parts of both the central server and the plurality of terminal devices are so connected to the distributed control parts for implementing the interactive control that the data storage in the central server occurs only upon the selection of a corresponding offer by a user of the terminal device.

7. A telecommunication network as claimed in claim 1, wherein the distributed control parts are formed as network-specific signaling parts on the basis of at least one of SIM cards, firmware, and applets/scripts.

8. A telecommunication network as claimed in claim 1, wherein the central server acts as an intermediate station in the loading of the software and the data onto a first of the plurality of terminal devices by one of a second of the plurality of terminal devices in the telecommunication network and a data terminal device in a data network which is linked to the telecommunication network.

9. A telecommunication network as claimed in claim 1, wherein the central server further includes a validation storage unit for storing at least one of validity data and authorization data in association with predetermined configuration codes as well as a comparison unit that is connected to the storage unit which compares the configuration codes that are transmitted by the plurality of terminal devices to stored configuration codes for the purpose of determining at least one of the validity of software stocks and data stocks and the usage authorization of a respective user.

10. A telecommunication network as claimed in claim 9, wherein the software stocks and the data stocks that are one of implemented in the plurality of terminal devices and downloaded into the plurality of terminal devices include application counter elements, the central server further including an arithmetic evaluation unit for evaluating the counter statuses of the application counter elements at one of predetermined times, time intervals, and times when the relevant terminal device logs onto the telecommunication network, for the purpose of achieving a use-based charging mode.

11. A telecommunication network as claimed in claim 10, wherein the central server includes an auxiliary information transmission unit which is connected to at least one of the comparison unit and the arithmetic evaluation unit for transmitting messages to the respective terminal device relating to at least one of the validity of implemented software, the usage authorization, and the application counter status for the respective user, the plurality of terminal devices including auxiliary information reception and display units for receiving and displaying the messages.

12. A telecommunication network as claimed in claim 1, wherein the software that can be downloaded onto the plurality of terminal devices includes at least one of software components and data for implementing non-network-bound auxiliary functions of the plurality of terminal devices.

13. A telecommunication network as claimed in claim 1, wherein the software and data that can be downloaded onto the plurality of terminal devices includes software components and data for implementing auxiliary services that are available in one of the telecommunication network and a data network that is connected to the telecommunication network.

14. A telecommunication network as claimed in claim 1, wherein the software and data that can be downloaded onto the plurality of terminal devices include update software and update data for updating software and data stocks that are stored in the plurality of terminal devices.

15. A method of operating a telecommunication network having a plurality of terminal devices of users, each with a predetermined hardware and software configuration, and a central server of an access or service provider, the method comprising the steps of:
interrogating the current hardware and software configurations of one of the plurality of terminal devices in an interrogation step at one of a time during logon onto the telecommunication network, predetermined times, and time intervals;
transmitting, in a transmission step, the current hardware and software configuration of the respective terminal device to the central server;
setting up in the central server and transmitting to the respective terminal device, based on the respectively transmitted hardware and software configuration, offer information for a user of a respective terminal device;
displaying, in the context of an interactive menu in the respective terminal device, the offer information together with one of a select and a reject request, one of a request and a reject signal of the user which is generated by the user being registered;
transmitting, together with the offer information, charging mode signals to the respective terminal device and displaying the charging mode signals in the context of the interactive menu for selection by the user, and registering a charging mode in the central server in response to a selection made by the user; and
downloading onto the respective terminal device by the central server, in response to the registered one of the request and the reject signals, software and/or data that are suitable for the respective terminal device and that are not already present at the respective terminal device.

16. A method of operating a telecommunication network as claimed in claim 15, the method further comprising the step of:
transferring to the central server, when one of the plurality of terminal devices log onto the telecommunication network, at predetermined times, and at time intervals, software and data that is implemented in the plurality of terminal devices for the purpose of data storage, and transferring the software and data by the central server back to the plurality of terminal devices again upon the occurrence of a predetermined condition.

17. A method of operating a telecommunication network as claimed in claim 15, the method further comprising the steps of:
storing at least one of the reject signals and the request signals in the central server for each individual terminal device; and
generating subsequent offer information using the at least one of the stored reject signals and the stored request signals as a filter.

18. A method of operating a telecommunication network as claimed in claim 15, the method further comprising the step of:
using the central server as an intermediate station in the loading of software and data onto a first of the plurality of terminal devices by one of a second of the plurality of terminal devices in the telecommunication network and a data terminal device in a data network that is linked to the telecommunication network.

19. A method of operating a telecommunication network as claimed in claim 15, the method further comprising the steps of:
storing at least one of validity data and authorization data in the central server in association with predetermined configuration codes;
comparing the data to configuration codes that are transmitted by the plurality of terminal devices; and
outputting to the plurality of terminal devices, as a result of the comparison, data relating to at least one of the validity of software and data stocks that are stored in the plurality of terminal devices and the usage authorization of the respective user.

20. A method of operating a telecommunication network as claimed in claim 15, the method further comprising the step of:
evaluating in the central server, when at least one of a terminal device logs on, predetermined times occur, and time intervals occur, counter statuses of application counter elements of the software and data stocks that are implemented in the plurality of terminal devices for the purpose of performing a use-based charging, an evaluation result being transmitted to the plurality of terminal devices.

21. A terminal device for use in a telecommunication network having a plurality of terminal devices of users, each with a predetermined hardware and software configuration, and a central server of an accessor service provider, the terminal device comprising:
a response transmitting part for transmitting a configuration code that identifies a currently implemented hardware and software configuration to the central server in response to an interrogation by the central server;
distributed control parts for implementing an interactive control of the downloading of at least one of software and data from the central server;
a charging mode display part for displaying at least one available charging mode for one of offered and selected software and data; and
a charging mode confirmation part for specifying the charging mode.

22. A terminal device for use in a telecommunication network as claimed in claim 21, wherein the distributed control parts include an offer display part for displaying offer information that is transmitted by the central server and a requesting part for selecting at least one of software and data that is offered for downloading for the purpose of outputting at least one of a request signal and reject signal to the central server.

23. A terminal device for use in a telecommunication network as claimed in claim 21, wherein the distributed control parts include signaling parts based on at least one of SIM cards, firmware, and applets/scripts.

24. A terminal device for use in a telecommunication network as claimed in claim 21, further comprising:
operating data transmitting and receiving parts for transferring at least one of software and data to and from the central server.

25. A terminal device for use in a telecommunication network as claimed in claim 21, further comprising:
an auxiliary information reception and display unit for receiving and displaying messages that are transmitted on the central server side relating to at least one of the validity of software and data that are implemented in the terminal device, the usage authorization, and a use-based charge status.
